(19) United States
(12) Patent Application Publication
(10) Pub. No.: US 2023/0106249 A1
(43) Pub. Date: Apr. 6, 2023

(54) CLOUD RADIO ACCESS NETWORK AGNOSTIC TO HYPERSCALE CLOUD HARDWARE

(71) Applicant: CommScope Technologies LLC, Hickory, NC (US)

(72) Inventors: Suresh N. Sriram, Bangalore (IN); Milind Kulkarni, Hawthorn Woods, IL (US); Arjun Nanjundappa, Richardson, TX (US)

(73) Assignee: CommScope Technologies LLC, Hickory, NC (US)

(21) Appl. No.: 17/902,709

(22) Filed: Sep. 2, 2022

(30) Foreign Application Priority Data
Oct. 4, 2021 (IN) 202141044885

(51) Int. Cl. H04W 28/18; H04W 72/04; H04L 5/00; H04W 72/08

(52) U.S. Cl. CPC H04W 28/18; H04W 72/0453; H04W 72/042; H04L 5/0048; H04W 72/087

(57) ABSTRACT

A Cloud Radio Access Network (C-RAN) includes at least one cloud node. In a flexi-split architecture, the at least one cloud node implements at least a portion of L1 processing for a distributed unit (DU) using a first at least one processing core and L2 processing for the DU using a second at least one processing core. The L1 and L2 processing can be implemented in the same or different cloud node and/or server as each other. The L1 processing and the L2 processing communicate via a network functional application platform interface (nFAPI). The cloud node(s) also determine at least one self-configuration decision, based on an available hardware configuration, which indicates a number of processor cores needed to implement the C-RAN using the hardware configuration and/or a channel configuration for the C-RAN to use when exchanging RF signals with a plurality of UEs.

### CROSS-REFERENCE TO RELATED APPLICATIONS

This application claims the benefit of Indian Provisional Patent Application No. 202141044885 (Attorney Docket 5984 IN P1/100.1999INPR) filed on Oct. 4, 2021, entitled “CLOUD RADIO ACCESS NETWORK AGNOSTIC TO HYPERSCALE CLOUD HARDWARE”, the entirety of which is incorporated herein by reference.

### BACKGROUND

In a 3GPP Fifth Generation (5G) cloud radio access network (C-RAN), geographically-separate remote units are controlled by at least one central unit (CU) and at least one distributed unit (DU) to provide wireless service to user equipment (UEs). It may be desirable to implement any (or all) C-RAN functionality in a way that is agnostic to any specific hardware.

### SUMMARY

A cloud radio access network (C-RAN) includes at least one cloud node. The at least one cloud node implements at least a portion of layer-1 (L1) processing for a distributed unit (DU) using a first at least one processing core. The at least one cloud node also implements layer-2 (L2) processing for the DU using a second at least one processing core. The L1 processing and the L2 processing are for an air interface used by the C-RAN to exchange radio frequency signals with at least one user equipment (UE). The L1 processing and the L2 processing communicate via a network functional application platform interface (nFAPI).

A method for layer-1 (L1) and layer-2 (L2) processing in a cloud radio access network (C-RAN). The method includes performing at least a portion of L1 processing for a distributed unit (DU) in at least one cloud node using a first at least one processing core. The method also includes performing L2 processing for the DU in the at least one cloud node using a second at least one processing core. The L1 and L2 processing are for an air interface used by the C-RAN to exchange radio frequency signals with at least one user equipment (UE). The L1 processing and the L2 processing communicate via a network functional application platform interface (nFAPI).

A cloud radio access network (C-RAN) implemented at least partially using at least one node. The at least one node is configured to determine a hardware configuration available to implement at least some components and configuration of the C-RAN. The at least one node is also configured to determine, based on at least the hardware configuration, at least one self-configuration decision indicating a number of processor cores needed to implement the C-RAN using the hardware configuration and/or a channel configuration for the C-RAN to use when exchanging radio frequency (RF) signals with a plurality of user equipment (UEs).

A method for self-configuring a cloud radio access network (C-RAN) implemented at least partially using at least one node, the method being performed by the at least one node. The method includes determining a hardware configuration available to implement at least some components and configuration of the C-RAN. The method also includes determining, based on at least the hardware configuration, at least one self-configuration decision indicating a number of processor cores needed to implement the C-RAN using the hardware configuration and/or a channel configuration for the C-RAN to use when exchanging radio frequency (RF) signals with a plurality of user equipment (UEs).

### DRAWINGS

Understanding that the drawings depict only exemplary configurations and are not therefore to be considered limiting in scope, the exemplary configurations will be described with additional specificity and detail through the use of the accompanying drawings, in which:

FIG. 1 is a block diagram illustrating an exemplary configuration of a communication system that includes 3GPP Fifth Generation (5G) components;

FIG. 2 is a block diagram illustrating example functional splits between the CU, DU, and RU(s), as well as different implementation options for cloud and non-cloud hardware;

FIG. 3 is a timing diagram illustrating a timing topology for a flexible C-RAN that can be implemented using different O-RAN splits and different possible implementations across cloud and non-cloud hardware;

FIG. 4 is a block diagram illustrating three different example configurations of cloud nodes in a scalable cloud environment;

FIG. 5 is a block diagram illustrating different processing threads in different functional containers (or pods);

FIG. 6 is a block diagram illustrating self-configuration of a C-RAN; and

FIG. 7 is a flow diagram illustrating a method for self-configuring a 5G C-RAN.

In accordance with common practice, the various described features are not drawn to scale but are drawn to emphasize specific features relevant to the exemplary configurations.

### DETAILED DESCRIPTION

A cloud radio access network (C-RAN) is one way to implement a distributed base station. Typically, for each cell implemented by a C-RAN, one or more central units (CUs) and distributed units (DUs) interact with multiple remote units (RUs) in order to provide wireless service to various items of user equipment (UEs). In a C-RAN, the RUs may communicate with at least one controller via a fronthaul interface.

The CU(s) and DU(s) in a 5G C-RAN may require significant computing resources to meet various coverage, throughput, users, and low latency demands placed upon it. These top-level requirements can drive the specific deployment configuration decisions such as bandwidth, multiple-input multiple-output (MIMO) Layers, spatial channels or reuse, coverage, users/slot, and/or latency constraints, etc. It can be difficult and complex to configure, design, qualify, and test CU(s) and DU(s) in different hardware in cloud or Private Network Functions (PNF) in a 5G C-RAN that satisfy all of these constraints across many different configurations. Additionally, since on-demand scaling of computing resources is desirable for CU and DU functionality changes dynamically, cloud-based (and/or PNF-based) implementations can provide great benefits when implementing a C-RAN.

Specifically, cloud migration can improve on-demand hardware utilization and reduce the upfront cost, so that resource-intensive configurations (e.g., exceeding the computing resources of a typical server) can be affordably implemented. The number of RUs, reuse layers, and/or MIMO antennas should be dynamically scalable (or “on-demand” scalable). This requires multiple deployment configurations. The RAN solutions should support an integrated CU+DU+RU configuration as well a distributed CU+DU+RU configuration. The above requirements make it difficult to achieve in the current cloud environment for at least the following reasons.

First, the C-RAN computing nodes are limited by per-server resources, e.g., limited external memory access, interfaces, common core memory, and/or Ethernet interface bandwidth. This means that physical server capability can be a limiting factor when deploying the C-RAN workloads.

Second, since the C-RAN solutions are expected to accommodate maximum configurations with respect to processor speed, Ethernet bandwidth, number of cores, etc., server instances may be fully blocked even for low computational channel processing. For example, if the computing node (e.g., implementing a CU and/or a DU) requires 48 processing cores, current solutions would require one server with 48 processing cores, memory to support 48 processing cores, and an Ethernet interface supporting backhaul and fronthaul speeds to accommodate 48 processing cores, etc. Therefore, if the computing node requires 48+4 cores, the 4-core server would be expected to have same capability as 48-core server(s) in terms of clock speed, Ethernet speed, etc.

Third, the interconnect interfaces (for the fronthaul, midhaul, and/or backhaul) Latency between the servers running the CU, DU and RU Connectivity have limitations in throughput and latency.

Fourth, cloud resource availability within desired latency of the physical coverage location.

The solutions proposed herein enable cloud-based implementation of at least part of a C-RAN. First, the instructions implementing the device management system (DMS), core network, CU, L2 portion of the DU, and/or L1 portion of the DU can flexibly handle any 3GPP-defined functional split between the CU and DU. In other words, the executable RAN instructions can be partitioned between various partitions of cloud and non-cloud hardware owned by different parties.

For example, some or all of the CU and/or DU herein may be implemented in the cloud as virtualized network functions (VNFs). A VNF can include one or more virtual machines or containers executing instructions (e.g., on servers or on one or more VNF hosting platforms) instead of having custom hardware appliances for each network function. Each VNF hosting platform can include at least one processor (e.g., a central processing unit (CPU)) and a memory which together store and execute code to realize aspects of the virtualized wireless base station in operation.

The Third Generation Partnership Project (3GPP) specifies functional splits between the CU, DU, and RUs (what processing happens in the RUs and what happens in the CU, DU), including O-RAN split 2, 6, 7.2x. The executable RAN instructions herein are compatible with any of the O-RAN splits as well as various implementation options between cloud and non-cloud hardware.

The second way that the present systems and methods enable cloud-based implementation of at least part of a C-RAN is self-configuration. Specifically, self-configuration instructions determine the capabilities of the customer's hardware (e.g., cloud servers and/or non-cloud servers) and channel configuration that can be supported for the given hardware capabilities then configure the functional entities (executable instructions) accordingly. This self-configuration can be done during deployment and/or dynamically, e.g., using predetermined rules around load or any other constraints.

For example, assume a cloud vendor provides a certain hardware configuration and/or the customer buys particular hardware to implement some or all of a C-RAN on. The self-software configuration of the present systems and methods will determine what channel configuration (e.g., RF channel bandwidth, duplexing scheme, number of MIMO layers, etc.) is best suited for that hardware, the processing thread configuration best suited for that hardware, and/or the which applications will be run on that hardware. For example, based on limitations of the provided hardware, the self-configuration of the present systems and methods may indicate support for the following configuration: a 60 or 80 MHz RF channel bandwidth (instead of a 100 MHz RF bandwidth); run time division duplexing (TDD) instead of frequency division duplexing (FDD); implement 2×2 multiple input multiple output (MIMO) instead of 4×4 MIMO; and/or support 32 RUs instead of 128 RUs, etc.

As used herein, the term “frequency reuse” refers to using the same frequency resource(s) for multiple sets of UEs, each set of UEs being under a different, geographically diverse set of RUs. This can include the same RU frequency resource being used to transmit to different UEs. In the downlink, multiple reuse layers of at least one RU can each transmit to a different UE on the same frequency at the same time (where each RU in a reuse layer is sufficiently RF-isolated from each RU in the other reuse layer(s)). On the uplink, each of multiple UEs can transmit to a different reuse layer of at least one RU on the same frequency at the same time (where each RU in a reuse layer is sufficiently RF-isolated from each RU in the other reuse layer(s)).

Some or all of the functions of the C-RAN 100 can be implemented using a scalable cloud environment in which resources used to instantiate each type of entity can be scaled horizontally (that is, by increasing or decreasing the number of physical computers or other physical devices) and/or vertically (that is, by increasing or decreasing the “power” (for example, by increasing the amount of processing and/or memory resources) of a given physical computer or other physical device). The scalable cloud environment can be implemented in various ways.

For example, the scalable cloud environment can be implemented using hardware virtualization, operating system virtualization, and application virtualization (also referred to as containerization) as well as various combinations of two or more of the preceding. The scalable cloud environment can be implemented in other ways. For example, the scalable cloud environment is implemented as a distributed scalable cloud environment comprising at least one central cloud and at least one edge cloud and/or at least one far-edge cloud.

Example 5G C-RAN

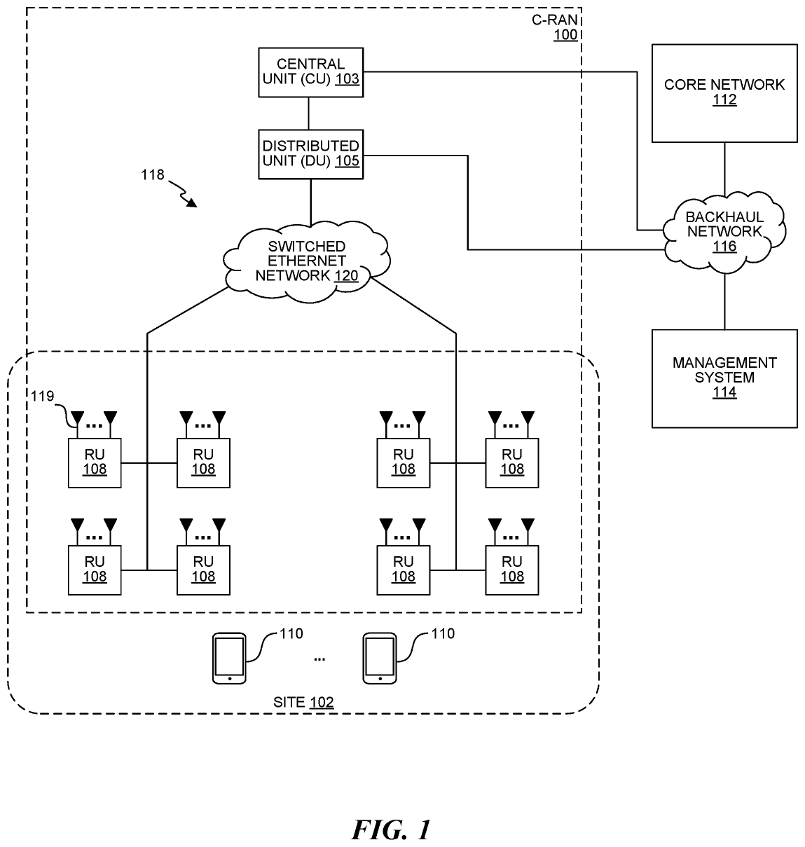

FIG. 1 is a block diagram illustrating an exemplary configuration of a system 100 that includes 3GPP Fifth Generation (5G) components. Optionally, the system 100 may additionally include 4G components. Each of the components may be implemented using at least one processor executing instructions stored in at least one memory. In some configurations, at least some of the components are implemented using a virtual machine. In some configurations, two or more of the components may be implemented on the same hardware as another component. Furthermore, any or all of the RAN components (e.g., CU 103, DU 105, and/or RUs 108), the core network 112, and/or the management system 114 may be implemented in one or more cloud servers or non-cloud servers.

The RUs 108 may be deployed at a site 102 to provide wireless coverage and capacity for one or more wireless network operators. Each RU 108 may include or be coupled to at least one antenna 119 used to radiate downlink RF signals to user equipment (UEs) 110 and receive uplink RF signals transmitted by UEs 110. The site 102 may be, for example, a building or campus or other grouping of buildings (used, for example, by one or more businesses, governments, other enterprise entities) or some other public venue (such as a hotel, resort, amusement park, hospital, shopping center, airport, university campus, arena, or an outdoor area such as a ski area, stadium or a densely-populated downtown area). The site 102 indoors, outdoors, or some combination of both.

Each UE 110 may be a computing device with at least one processor that executes instructions stored in memory, e.g., a mobile phone, tablet computer, mobile media device, mobile gaming device, laptop computer, vehicle-based computer, a desktop computer, etc. Each baseband controller 104 and RU 108 may be a computing device with at least one processor that executes instructions stored in memory. Furthermore, each RU 108 may implement one or more instances (e.g., modules) of a radio unit 108.

The system 100 in FIG. 1 may also be referred to here as a “C-RAN” or a “C-RAN system.” The C-RAN 100 may optionally implement frequency reuse where the same frequency resource(s) are used for multiple sets of UEs 110, each set of UEs 110 being under a different, geographically diverse set of RUs 108.

Fifth Generation (5G) standards support a wide variety of applications, bandwidth, and latencies while supporting various implementation options. For example, 5G control plane interfaces between components (e.g., between the CU 103 and DU 105) provide control plane connectivity, while user plane interfaces provide user plane connectivity. More explanation of the various devices and interfaces in FIG. 1 can be found in 3GPP TR 38.801 Radio Access Architecture and Interfaces, Release 14 (available at https://portal.3gpp.org/desktopmodules/Specifications/SpecificationDetails.aspx?specificationId=3056), which is incorporated by reference herein.

FIG. 1 illustrates a C-RAN 100 implementing an example of a 5G Next Generation NodeB (gNodeB). The architecture of a Next Generation NodeB (gNodeB) is partitioned into a 5G Central Unit (CU) 103, one or more 5G Distributed Unit (DU) 105A-B and one or more 5G Remote Units (RU) 108. Depending on the functional split used, a 5G Central Unit (CU) 103 is a node that includes the gNodeB controller functions such as the transfer of user data, mobility control, radio access network sharing, positioning, session management, etc. The 5G CU 103 controls the operation of the Distributed Units (DUs) 105 over an interface (including F1-C and F1-U for the control plane and user plane, respectively).

In some configurations (not shown in FIG. 1), the CU 103 can be further partitioned into a central unit control-plane (CU-CP) and one or more central unit user-plane (CU-UPs) together implementing L3 processing, and each DU 105 configured to implement L2 and upper part of L1. In this example, each RU 108 is configured to implement the radio frequency (RF) interface and lower physical layer control-plane and user-plane functions of the gNodeB. Each RU 108 is typically implemented as a physical network function (PNF) and is deployed in a physical location where radio coverage is to be provided. Each DU 105 is typically implemented as a virtual network function (VNF) and, as the name implies, is typically distributed and deployed in a distributed manner in the operator's edge cloud. Each CU-CP and CU-UP are typically implemented as virtual network functions (VNFs) and, as the name implies, are typically centralized and deployed in the operator's central cloud. Additionally, the CU-CP VNF and CU-UP VNF can be centralized and deployed in an edge cloud and/or PNF. In other embodiments, one or both may be deployed in a central cloud. In some configurations, the CU 103 (e.g., including a CU-CP VNF and CU-UP VNF) and the entities used to implement it are communicatively coupled to each DU VNF served by the CU 103 (and the DU VNF(s) used to implement each such DU 105). In the example shown in FIG. 1, the DU VNF(s) used to implement a DU 105 are communicatively coupled to each RU 108 served by the DU VNF using a fronthaul network 118 (for example, a switched Ethernet network 120 that supports the IP).

The Distributed Units (DUs) 105 may be implemented using node(s) that implement a subset of the gNodeB functions, depending on the functional split (between CU 103 and DU 105). The operation of each DU 105 is controlled by a CU 103, which may be divided into CU-CP and CU-UP portions.

The Third Generation Partnership Project (3GPP) has adopted a layered model for the 5G radio access interface. Generally, and without limitation, the RUs 108 perform analog radio frequency (RF) functions for the air interface as well as some portion of the digital Layer-1 (PHY or L1) processing, where the DU 105 can also perform at least a portion of the PHY processing in some configurations as described further below. Optionally, in some split-8 configurations, low PHY processing may not be needed. Generally, and without limitation, the CU 103 or the DU 105 performs Layer-2 (L2) processing, and the CU 103 performs Layer-3 (L3) processing (of the 3GPP-defined 5G radio access interface protocol) functions for the air interface. Any suitable split of L1-L3 processing among the C-RAN 100 components may be implemented, as described in more detail below.

In FIG. 1, the C-RAN 100 implementing the example Next Generation NodeB (gNodeB) includes a single CU 103, which handles control plane functions and user plane functions. The 5G CU 103 (in the C-RAN 100) may communicate with at least one wireless service provider's Next Generation Cores (NGC) 112 using 5G NGc and 5G NGu interfaces. The CU 103 may be communicatively coupled to the core network 112 and management system 114 via a backhaul network 116.

The C-RAN 100 may implement one or more cells. In some configurations, each RU 108 in the C-RAN 100 will belong to the same cell(s), in which case each RU 108 in the C-RAN 100 will broadcast the same Cell-ID(s).

Any of the interfaces in the C-RAN 100 of FIG. 1 may be implemented using a switched ETHERNET (or fiber) network. Additionally, if multiple CUs 103 are present (not shown), they may communicate with each other using any suitable interface, e.g., an Xn (Xn-c and Xn-u) and/or X2 interface. A backhaul interface may facilitate any of the F1-C, F1-U, and/or O1/2 interfaces. The fronthaul interface may facilitate the O-RAN NG-IQ, M-plane and/or S-plane interfaces, e.g., S1-U. Furthermore, C-RAN 100 can be connected to a mobility management entity (MME) via a S1MME interface.

The components of the C-RAN 100 (e.g., CU 103, DU 105, and/or RUs 108) can be implemented so as to use an air interface that supports one or more of frequency-division duplexing (FDD) and/or time-division duplexing (TDD). Also, the components of the C-RAN 100 can be implemented to use an air interface that supports one or more of the multiple-input-multiple-output (MIMO), single-input-single-output (SISO), single-input-multiple-output (SIMO), and/or beam forming schemes. Moreover, the baseband controller 104 and the remote units 108 can be configured to support multiple air interfaces and/or to support multiple wireless operators.

In some configurations, in-phase, quadrature-phase (I/Q) data representing pre-processed baseband symbols for the air interface is communicated between the DU 105 and the RUs 108, e.g., on an NG-iq interface. Communicating such baseband I/Q data typically requires a relatively high data rate front haul.

In some configurations, a baseband signal can be pre-processed at a source RU 108 and converted to frequency domain signals (after removing guard band/cyclic prefix data, etc.) in order to effectively manage the fronthaul rates, before being sent to the DU 105. The RU 108 can further reduce the data rates by quantizing such frequency domain signals and reducing the number of bits used to carry such signals and sending the data.

Flexi-Split Architecture

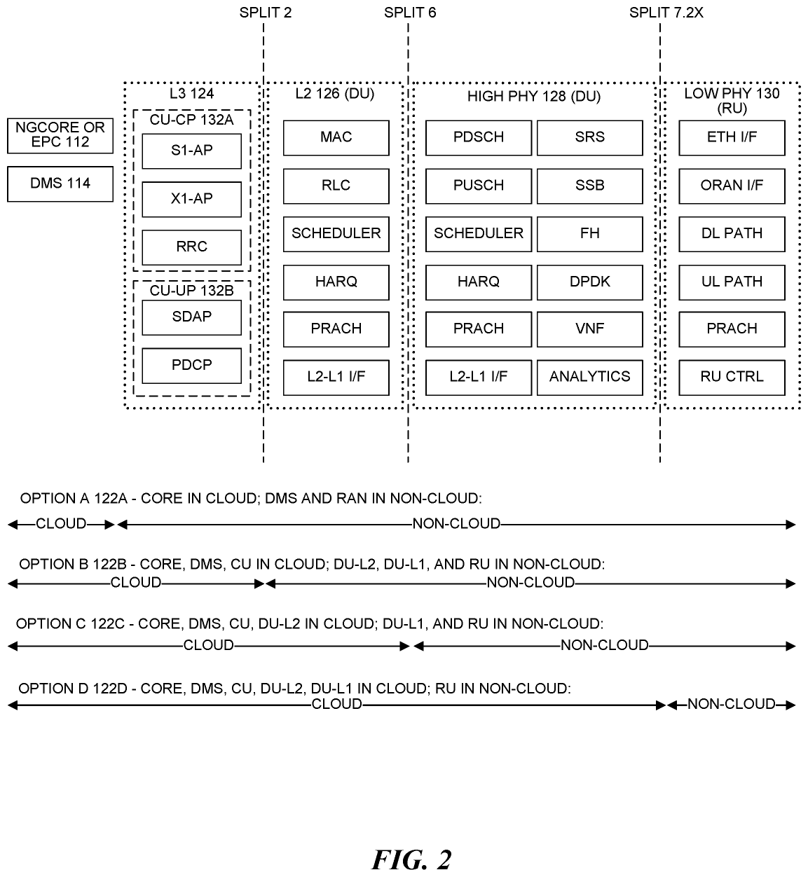

FIG. 2 is a block diagram illustrating example functional splits between the CU 103, DU 105, and RU(s) 108, as well as different implementation options for cloud and non-cloud hardware. FIG. 2 illustrates the different processing in the CU 103, DU 105, and RUs 108 for the air interface, including analog radio frequency (RF) functions for the air interface as well as digital Layer-1 (L1) processing 128-130, Layer-2 (L2) processing 126, and Layer-3 (L3) processing 124 for the 3GPP-defined 5G radio access air interface. Each of the layer processing 124-130 is shown in FIG. 2 with the various processes for that layer.

As is described below, L3 processing 124 is generally performed in the CU 103; L2 processing 126 can be performed in the DU 105 depending on the O-RAN split used; high physical layer (PHY or L1) processing 128 is generally performed in the DU 105; and low PHY processing 130 is generally performed at the RUs 108. However, other configurations are possible.

Since 5G solutions emphasize vertical and horizontal scaling in the cloud, any C-RAN 100 implementation should be compatible with the different O-RAN splits (e.g., 2, 6, 7.2x) and different possible implementations across cloud and non-cloud hardware. For example, the following hardware implementations could be used (cloud/non-cloud):
1. Option A 122A: core/DMS+CU+DU+RU;
2. Option B 122B: DMS+core+CU/DU−L2+DU−L1+RU;
3. Option C 122C: DMS+core+CU+DU−L2/DU−L1+RU; or
4. Option D 122D: DMS+core+CU+DU−L2+DU−L1 all on cloud with only RU in non-cloud.

Thus, the flexible C-RAN 100 architecture of the present systems and methods should be compatible with different functional partitions (O-RAN splits 2, 6, 7.2×) and different implementation Options A-D.

As noted above, the Third Generation Partnership Project (3GPP) specifies functional splits between the RAN components (what processing happens in which component). For example, a “7.2x” protocol split (also referred to as an “split 7.2x”) is specified by the Open Radio Network Alliance (O-RAN) and designates that a portion of physical layer (Layer-1 or “L1”) processing 128-130 is performed at the RU 108 and a portion at the DU 105. In other words, the O-RAN 7.2x split is in the middle of the physical layer. In split 7.2x, high PHY processing 128 is performed at the DU 105, and low PHY processing 130 and analog RF processing are performed at the RUs 108. In some configurations using the O-RAN split 7.2x, an O-RAN interface (e.g., O-RAN 1.0 interface) can be used to communicate between the DU 105 and RUs 108 on the fronthaul network 118. More information about the O-RAN 1.0 interface can be found in O-RAN-WG4.CUS.0-v01.00 Control, User and Synchronization Plane Specification, Version 1.00 (available at https://www.o-ran.org/specifications).

The term “high” with respect to RLC, MAC, and PHY refers to the upper sublayers of the layer in question. Without limitation, the high PHY processing 128 (performed at the DU 105 in split 7.2x) may include any of the following: encoding, resource element mapping, MIMO mapping, scrambling, modulation, etc. The term “low” with respect to RLC, MAC, and PHY refers to the lower sublayers of the layer in question. Without limitation, the low PHY processing 130 (performed at the RU 108 in split 7.2x) may include, without limitation, any of the following: digital-to-analog conversion, pre-coding, beamforming, precoding, analog RF control processing, etc.

Additionally, in an O-RAN split 7.2x, the DU 105 can implement various processes, e.g., Physical Downlink Shared Channel (PDSCH), Physical Downlink Control Channel (PDCCH), Physical Uplink Control Channel (PUCCH), Sounding Reference Signal (SRS), Physical Broadcast Control Channel (PBCH), Primary Synchronization Signal (PSS), Secondary Synchronization Signal (SSS), Cell Specific Reference Signal (CS-RS), Tracking reference Signal, a Demodulation Reference Signal (DMRS), a Phase Tracking Reference Signal, Physical Uplink Shared Channel (PUSCH), L1 scheduling, L1 Physical Random Access Channel (PRACH), L2-L1 interface, Sounding Reference Signal (SRS), Synchronization Signal Block (SSB), L1 fronthaul, virtual network functions (VNF), and/or analytics, etc. Additionally, in an O-RAN split 7.2x, the RUs 108 can implement various processes, e.g., ETHERNET interface processing, O-RAN interface processing, downlink path processing, uplink path processing, Physical Random Access Channel (PRACH) processing, and/or various other RU 108 control processes. In some configurations, the high PHY processing (at the DU 105) can communicate with the RUs 108 via nFAPI, thus at least some channels (e.g., SRS, SSB) can be processed via nFAPI.

In an O-RAN split 6, L2 processing 126 (e.g., Medium Access Control (MAC), Radio Link Control (RLC), MAC scheduling, Hybrid Automatic Repeat Request (HARD) processing, etc.) and high physical layer (PHY) 128 processing are both performed using O-RAN interface definition using FAPI Interface, e.g., in a DU 105 (which may or may not be implemented in the same physical server). Low PHY processing 130 and analog RF processing may then be performed at the DU 105 and/or RUs 108. In some configurations of O-RAN split 6, the 5G network functional application platform interface (nFAPI) can be used to communicate between the L2 processing 126 (in the DU 105) and the high PHY processing 128 (also in the DU 105). More information about the nFAPI interface can be found in 5G_nFAPI_specifications v225.2.0 (available at https://scf.io/en/documents/225_5G_nFAPI_specifications.php). In some configurations of O-RAN split 6, there is no split of the high PHY 128 and low PHY 130, e.g., all PHY processing 128-130 and analog RF functions are performed in the DU 105 or all in the RUs 108. Alternatively, the DU 105 split according to O-RAN split 6 can be combined with O-RAN split 7.2x to provide a higher degree of freedom in different deployment use cases, cloud Vendors, and lower cost. Typically and without limitation, all L3 processing 124 (e.g., RRC and PDCP portions) is performed in a CU 103 for O-RAN split 6.

Implementing O-RAN split 6 can be challenging because it carries the approximately 10% more data compare to standard F1 split (split-2); the L1— L2 requires near real-time latency (e.g., producing an output within milliseconds or microseconds) for fast scheduling and end-to-end (E2E) latency reduction; and may require trusted L2 network topology to avoid the IPSEC on L1— L2 interface.

In a common server implementation of split 6 (both portions of DU 105 in the same physical server), the traffic increase between L1-L2 within the server has no impact as no external routing. The data is transmitted within the server with socket interface to maintain common software. Additionally, only processing latency is present because transport distance-based latency is not applicable as the transmit/receive happens on same server.

In a common server implementation of split 6 (different portions of DU 105 implemented in physically-remote servers), split servers transporting the 10% additional load is insignificant. In the event of connectivity constraint deployments, backhaul aware load balancing to be supported to throttle the traffic. Additionally, the physical layer is running on sub-single-slot latency. This allows additional slot buffer time compared to commercial off-the-shelf (COTS)-based solutions (including vendor-specific hardware as well). The gained latency (e.g., 500 microseconds per 1 millisecond) utilized in the split 6 allows distance of 50 km or even 100 km separation with early scheduling. Additional distance can be supported by increasing the E2E latency by 1 ms which would allow additional 100 km.

In some configurations, both O-RAN split 6 and O-RAN split 7.2x are used (and optionally split-8 is also used). This can provide a higher degree of freedom in far-edge and edge use cases. The far-edge and edge can operate with laptop, desktop, server and SoC architecture. The customers can buy a desktop or laptop along with RU(s) 108 and run the 5G C-RAN 100. Hypercloud providers can provide the far-edge connectivity. This would address private networks and Industrial IoT 4.0.

O-RAN split 8 can also be used in which all L2 processing 126 and L1 processing 128, 130 (and optionally L3 processing 124) is performed on the DU 105 and the RU 108 performs only analog RF processing. In some configurations, O-RAN splits 6, 7.2x, and/or 8 are used together.

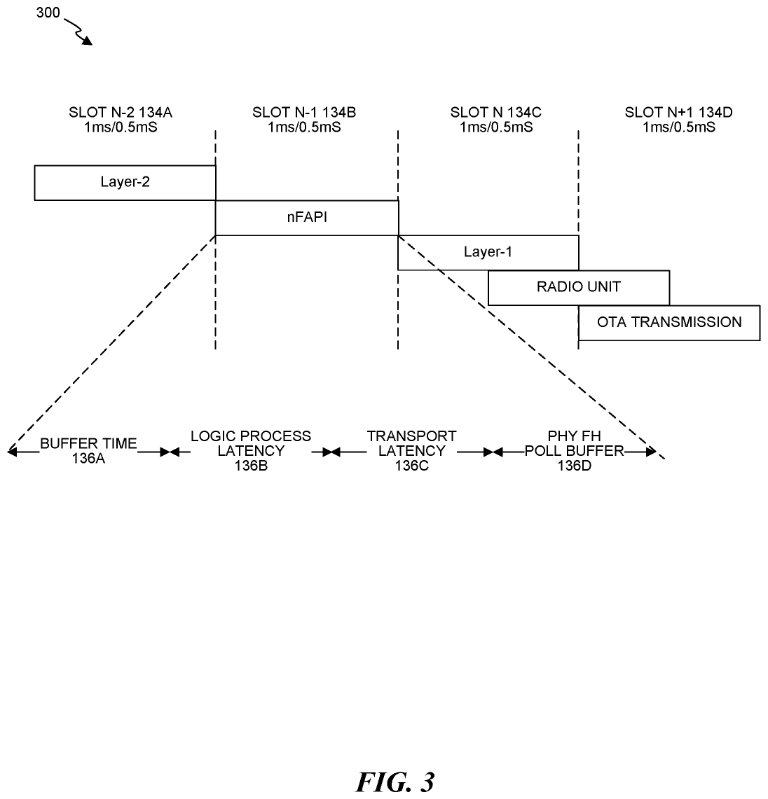

FIG. 3 is a timing diagram 300 illustrating a timing topology for a flexible C-RAN 100 that can be implemented using different O-RAN splits (e.g., 2, 6, 7.2x) and different possible implementations across cloud and non-cloud hardware. Specifically, FIG. 3 illustrates time 136A-D consumed (e.g., by C-RAN 100 processing and other latency) during a series of over-the-air slots 134A-D, e.g., where the C-RAN 100 processing operates backward relative to the order the OTA slots 134A-D are transmitted.

As noted above, it is desirable that C-RAN 100 deployments support O-RAN splits 2, 6, or 7.2x across various cloud/non-cloud hardware combinations. This compatibility poses a challenge in that the CU 103, DU 105, and RU 108 can have different latency constraints, e.g., 10 milliseconds at the CU 103, 215 microseconds at the DU 105, and 100 microseconds at the RU 108. Some C-RAN 100 timing topologies, therefore, limit the CU-DU physical distance, e.g., to 50 km (for 30 KHz transmission frequencies) and 100 km (for 15 KHz transmission frequencies).

In order to address the split 6 latency issue (where the L2 processing 126 at a first DU 105 portion is physically separate from the L1 processing 128 at a second DU 105 portion), a latency buffer may be introduced. In split 6 configurations, the DU 105 is split into two portions, the L1-DU performing at least the high PHY processing 128 & L2-DU performing L2 processing 126. A latency buffer is used in each portion of the DU 105, where the latency is divided into four units shown in the N−1 slot 134B: buffering time 136A; logic processing latency 136B; transport latency 136C; and PHY fronthaul poll buffer 136D.

Conventionally, the DU 105 portion performing L2 processing 126 may use an interface to communicate with the DU 105 portion performing high PHY processing 128. However, in order to make the L1-L2 interface split-6 compatible, a buffering time 136A can be accounted for at the DU 105 portion performing L2 processing 126 so that the DU 105 portion performing L2 processing 126 can directly communicate with the DU 105 portion performing high PHY processing 128 over nFAPI. With this buffer, the other three timing portions (logic processing latency 136B, transport latency 136C, DU-PHY polling latency 136D) can consume one slot 134B worth of timing. This will accommodate physical distances of up to a 100 km distance between the DU 105 portion performing L2 processing 126 can directly communicate with the DU 105 portion performing high PHY processing 128.

The logic processing latency 136B may result from various processing, e.g., IP Security (IPsec), L2 application to socket copy, etc. Transport latency 136C refers to the time it takes for data to be transmitted between the DU 105 portion performing L2 processing 126 can directly communicate with the DU 105 portion performing high PHY processing 128. DU-PHY polling latency 136D refers to the time built in for polling between the DU 105 portion performing L2 processing 126 can directly communicate with the DU 105 portion performing high PHY processing 128.

In one configuration, the communication between L2-L1 will use a socket interface, e.g., Ethernet. Similarly, the interface between L1-RU can utilize a socket interface, e.g., Ethernet. In socket communication, the transmit time latency is not real-time. In order to increase efficiency pipeline processing is performed, which includes sending small portion of data to and forward so the next module can start processing without waiting for full data. When the data is sent/received in smaller packets, the receiver entity has to perform the polling during which the receiver continually looks for packets at some interval. In the present systems and methods, the fronthaul interface 118 is being used for the L1-L2 and L1-RU interfaces. They are separated via VLAN IDs and a single function does both. When the fronthaul module polls it gets all packets and differentiates whether they are RU packets or L2 packets and routes to respective intended functions.

If there is a common single server performing L1 processing 128 and L2 processing 126, then latency will be low. If a distributed server is used, there will be added latency in the extra slot in order to support separation between L1 processing 128 and L2 processing 126. The DU-RU fronthaul not impacted by the Split-6 separation. Conventionally, the fronthaul window allows 20 km separation and can be further increased on need.

Depending on the distance between the DU 105 portion performing L2 processing 126 and the DU 105 portion performing high PHY processing 128, the latency buffer can be increased. This latency buffer may also include a scheduling impact latency buffer (1-10 ms impact on scheduling latency). There should be no impact for the deployments up to approximately 200 kmph mobility. Higher mobility can be achieved by incorporating additional signal processing. No impact latency buffer up to 1 ms by scheduling in advance. The overall latency impact is very minimal as all the commercial off-the-shelf (COTS) systems are operating with three slots of latency and RAN-specific system is operating with one slot of latency.

Hardware Agnostic Architecture

Available cloud hardware may contain different hardware, e.g., different CPU, Ethernet Card, CPU Frequency, memory interface bandwidth etc. In-order to address the above constraints, we are introducing the hardware agnostic architecture.

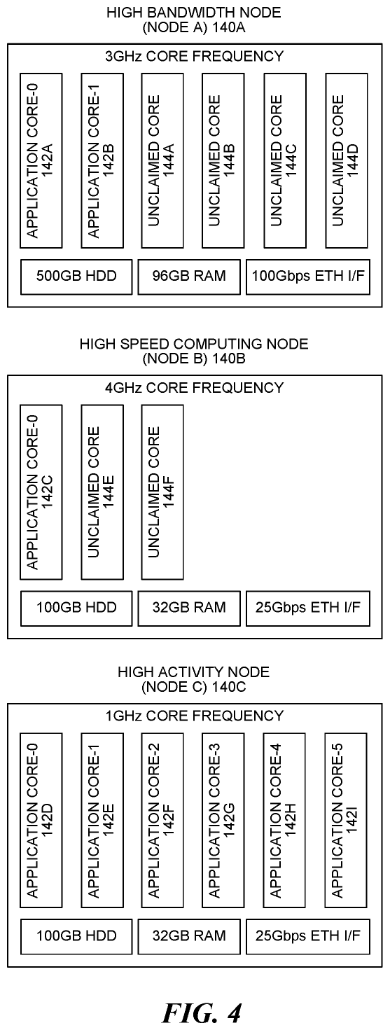

FIG. 4 is a block diagram illustrating three different example configurations of cloud nodes 140A-C in a scalable cloud environment. Each node 140A-C may be a logical computing entity implemented using at least one cloud server. In some implementations, a single node 140A-C is implemented on a single server. Additionally or alternatively, more than one node 140A-C may be implemented on a single server. Additionally or alternatively, a single node 140A-C can be implemented across more than one server.

Each node 140A-B may require one or more processing cores 142A-I, 144A-F. Some processing cores 142A-I, 144A-F are available cores 142A-I (available to implement RAN container(s)), while some are unclaimed cores 144A-F (not available to implement RAN container(s)). The hardware agnostic architecture herein enables RAN software to adapt to different hardware configurations in a scalable cloud environment implementing the C-RAN 100. It is understood that the nodes 140A-C are merely exemplary and should not be interpreted as limiting the different hardware configurations that can be used with the present systems and methods. Thus, the RAN software can be divided into micro services based on their demands on latency, CPU requirements, memory requirements, clock speed, Ethernet speed, etc. This removes the dependency of having one single server having maximum specifications of all of the above.

As noted above, the CU-CP, CU-UP, and DU 105 may be implemented as virtual network functions (VNFs) on one or more VNF platforms and the RUs 108 may be implemented as physical network functions (PNFs). The scalable cloud environment implementing at least portions of the C-RAN 100 can include one or more cloud worker nodes that are configured to execute cloud native software that, in turn, is configured to instantiate, delete, communicate with, and manage one or more virtualized entities (e.g. the CU-CP VNF, CU-UP VNF and DU VNF). Each of the cloud worker nodes may comprise one or more virtualized entities and cloud native software, the cloud native software may comprise a host operating system, and the virtualized entities comprise one or more virtual network functions (VNFs), and each VNF further comprises one or more functional containers (also called PODs). In another example, the cloud worker nodes comprise respective clusters of physical worker nodes, the cloud native software comprises a hypervisor (or similar software), and the virtualized entities comprise virtual machines.

With reference to FIG. 4, example Node A 140A is well suited for high bandwidth activity because it implements a 100 Gbps Ethernet interface as opposed to the 25 Gbps Ethernet interfaces in Node B 140B and Node C 140C. Example Node B 140B is well suited for high-speed computing because it implements 4 GHz core frequency as opposed to 3 GHz in Node A 140A and 1 GHz in Node C 140C. Example Node C 140C is well suited for high activity because it has six processing cores 142D-I available to implement RAN containers as opposed to two cores 142A-B in Node A 140A and one core 142C in Node B 140B.

Several problems can arise when implementing a C-RAN 100. First, overprovisioning server(s) running the C-RAN 100 components. For example, in order to support a 100 MHz TDD system (including L1-L3 across RUs 108, DU 105, CU 103), assume a C-RAN 100 requires 30 processing cores 142A-I, 144A-F. Typically, all cores 142A-I, 144A-F would be expected to operate at the highest frequency, memory interface, clock speed, CPU architecture, and/or Ethernet interface that any of the RAN modules requires (even if that module operates on a single one of the 30 processing cores 142A-I, 144A-F). Therefore, all of the servers implementing the C-RAN 100 would need to be dimensioned with the highest core frequency required by any single RAN module, the highest Ethernet bandwidth required by any single RAN module, and the highest memory interfaces required by any single RAN module, etc. For example, the L1 processing (e.g., high PHY 128) might require 4 GHz processing frequency because it is subject to a real-time latency constraint. In that case, all 30 cores 142A-I, 144A-F used to implement the entire C-RAN 100 (including L1 and non-L1 processing) would also have 4 GHz cores. Similarly, if L1 processing (e.g., high PHY 128) requires a 100 Gbps Ethernet interface, all 30 cores 142A-I, 144A-F used to implement the entire C-RAN 100 (including non-L1 processing) would need to support the 100 Gbps Ethernet interface. Similar for memory constraint. Accordingly, the conventional C-RAN 100 software architecture results in overprovisioned hardware in total because all 30 cores 142A-I, 144A-F would have to support the highest-consuming RAN module in terms of processing frequency, Ethernet interface bandwidth, memory, etc.

Second, the clock frequency of cores 142A-I, 144A-F in a server typically has to come down as the number of cores 142A-I, 144A-F in a server goes up in order to keep the power consumption of the server within limits.

Third, if cloud vendors are used for large deployments (e.g., 30 or 40 cloud servers), they may not have all the edge nodes 140A-C needed, which can cause RUs 108 to interact with cloud nodes 140A-C very far away from the RU 108 locations. Large RU-DU and/or DU-CU distances are incompatible with 5G latency constraints (where latency increases with distance). So different configurations of cloud nodes 140A-C will be available at different physical locations.

Accordingly, the RAN software herein is divided into multiple micro-services (or “containers” or “pods”), which enables the software to analyze the available cloud platform hardware and determine which containers/pods run on which cores 142A-I, 144A-F and nodes 140A-C. In other words, the present systems and methods allow different containers/pods to be implemented on different (e.g., spatially-separated) cloud nodes 140A-C with different hardware configurations instead of requiring that all RAN containers run on cores 142A-I, 144A-F in a bank of proximate servers with a common hardware configuration.

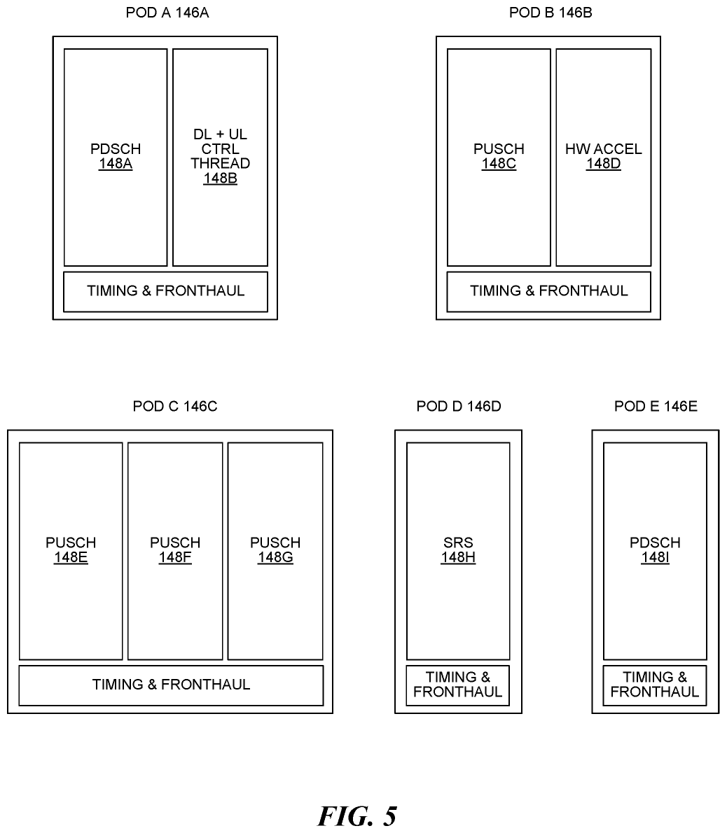

FIG. 5 is a block diagram illustrating different processes (or processing “threads”) 148A-I in different functional containers (or pods) 146A-E. As noted above C-RAN 100 workloads are divided into multiple self-containing containers (or “pods”) 146A-E. These self-contained pods 146A-E can perform end to end functionality. These containers 146A-E are each classified as being mandatory or optional.

Mandatory containers are required for the operation of the C-RAN 100 and may be referred to as “core” processing or functionality. For example, the PDSCH 148A and DL+UL control process 148B in POD A 146A along with the PUSCH process 148C in POD-B might be mandatory, while the rest of the containers might be optional. Mandatory containers cannot be dynamically removed.

Optional containers 146A-E are used for scaling (e.g., in response to an increase in network demand). Optional containers 146A-E can be dynamically deployed and removed, e.g., optional containers 146A-E can be added on-demand to support coverage, capacity, users etc. For example, if there is high uplink activity, we can add more optional PUSCH processes 148E-G in POD C 146C. If additional SRS signaling is required, another optional SRS process 148H in POD D 146D can be added. If more PDSCH signaling is required, another optional PDSCH process 1481 can be added in POD E 146E. Different processes 148A-I within the same container/pod 146A-E can be classified differently, e.g., one mandatory and one optional. New optional containers 146A-E can be added or removed dynamically.

The base variant (with minimal optional containers) can run on a desktop computer after which scaling of the C-RAN 100 could optionally be performed with additional hardware. Pooling can be done at the container level.

A single core 142A-I, 144A-F could implement a single container 146A-E or more than one container 146A-E, depending on the resources needed by the container(s) 146A-E. Alternatively, a single container 146A-E could be implemented using more than one core 142A-I, 144A-F or multiple containers 146A-E could be implemented using a single core 142A-I, 144A-F.

Without limitation, the CU-CP portion 132A of the L3 processing 124 can include S1-AP, X1-AP, and/or RRC processes 148A-I; the CU-UP portion 132B of the L3 processing 124 can include SDAP and/or PDCP processes 148A-I; the L2 processing 126 can include MAC, RLC, scheduler, HARQ, PRACH, and/or L2-L1 interface processes 148A-I; the high PHY processing 128 can include PDSCH, PUSCH, scheduler, HARQ, PRACH, L2-L1 interface, SRS, SSB, fronthaul, DPDK, VNF, and/or other analytics processes 148A-I; and the low PHY processing 130 can include Ethernet interface, O-RAN interface, downlink path, uplink path, PRACH, and/or RU control processes 148A-I. The high PHY processing 128 could also include processing for Physical Downlink Control Channel (PDCCH), Physical Uplink Control Channel (PUCCH), Sounding Reference Signal (SRS), Physical Broadcast Control Channel (PBCH), Primary Synchronization Signal (PSS), Secondary Synchronization Signal (SSS), Cell Specific Reference Signal (CS-RS), Tracking reference Signal, Demodulation Reference Signal (DMRS), and/or Phase Tracking Reference Signal.

Self-Configuration

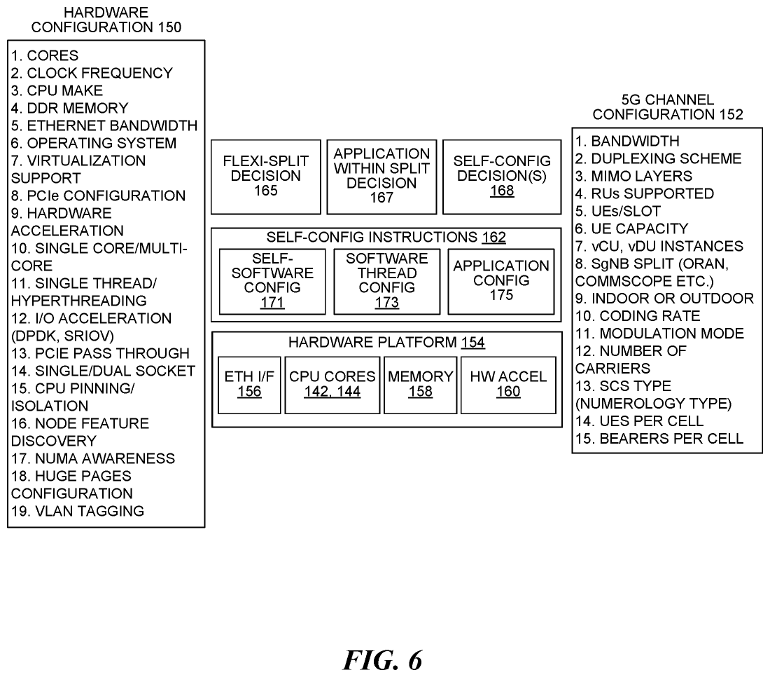

FIG. 6 is a block diagram illustrating self-configuration of a C-RAN 100. Specifically, FIG. 6 illustrates a high-level block diagram of the executable sets of instructions that self-configure a C-RAN 100 (e.g., specific implementation details) based on an available hardware configuration 150. The hardware configuration 150 may indicate the hardware specifications of the available cloud node(s) 140A-C (including central cloud nodes, edge cloud nodes, and/or far-edge cloud nodes) and/or non-cloud hardware provided by the customer.

The hardware platform 154 of the scalable cloud environment uses nodes 140A-C (e.g., servers) with specific hardware configuration 150 (shown in box on the left side of FIG. 6). Without limitation, the hardware configuration 150 can indicate any of the following: number of processing cores 142A-I, 144A-F available, clock frequency of the processing cores 142A-I, 144A-F, CPU make, amount of memory 158, bandwidth of an Ethernet interface 156, operating system, virtualization support, PCIe configuration, hardware acceleration 160, etc. Other possible parameters that may be indicated in the hardware configuration 150: whether the CPU(s) on the node have a single processing core 142A-I, 144A-F or multiple processing cores 142A-I, 144A-F, if the processing core(s) 142A-I, 144A-F use a single thread or hyperthreading, input/output acceleration (e.g., DPDK, SRIOV), PCIe pass-through, whether the CPU is a single or dual socket configuration, the CPU pinning/isolation, details of node feature discovery, Non-uniform memory access (NUMA) awareness, huge pages configuration, and/or virtual local area network (VLAN) tagging.

The 3GPP 5G standards also impose various channel configurations 152 (shown in box on the right side of FIG. 6). Without limitation, the channel configuration 152 can indicate any of the following: RF bandwidth, duplexing scheme (TDD or FDD), number of MIMO layers (e.g., 2×2, 4×4, etc.), number of RUs 108 to support, number of radio resources allocated over a slot duration, number of UEs 110 per slot, number of UEs 110 supported (UE 110 capacity), etc. Other possible parameters that may be indicated in the channel configuration 152: coding rate, modulation mode, number of carriers, subcarrier spacing (SCS) type (also called numerology, UEs 110 per cell, uplink and/or downlink reuse factor, and/or bearers per cell.

The self-configuration instructions 162 will make self-configuration decision(s) 168 based on at least the hardware configuration 150 and/or the channel configuration 152. This will enable high-demand containers/pods to be implemented on nodes 140A-C capable of supporting their needs, while allowing low-demand containers/pods to be implemented on nodes 140A-C with lower hardware specifications, e.g., lower core frequency, less memory, lower Ethernet interface bandwidth, etc. This will also enable an accurate determination of the number of processing cores 142A-I, 144A-F needed for processes in the L1-L3 processing.

For example, if a cloud vendor has a certain hardware configuration and/or the customer buys particular hardware that they want to run the RAN software on, (1) applications will be selected for the C-RAN 100, e.g., based on the hardware configuration 150 and/or channel configuration 152; (2) processes 148A-I will be selected and assigned to different containers 146A-E, e.g., based on the hardware configuration 150 and/or channel configuration 152; and/or (3) containers 146A-E will be assigned to different processing cores 142A-I, 144A-F, e.g., based on the hardware configuration 150 and/or channel configuration 152.

In other words, the self-configuration instructions 162 reads the underneath hardware capabilities (as indicated in the hardware configuration 150) and/or the 5G channel configuration 152 that can be supported for given hardware capabilities and accordingly configures the PODs 146A-E, the processing threads, and the applications that will implement the C-RAN 100 (on cloud and/or non-cloud hardware). This self-configuration operation can be done during deployment and/or dynamically and is compatible with any rules relating to load management or control processes for any other metrics.

The self-configuration decision(s) 168 can include the number and/or type of processing cores 142A-I, 144A-F needed to implement the C-RAN 100; the processing threads needed to implement the C-RAN 100; and/or the applications needed to implement the C-RAN 100. Additionally or alternatively, the (wireless) channel configuration 152 may be determined or modified by the self-configuration decision(s) 168. For example, the self-configuration decision(s) 168 can determine or modify the following channel configuration 152 parameters in light of the hardware configuration 150: a particular RF bandwidth, a particular duplexing scheme, a particular number of MIMO layers, a particular number of RUs 108, a number of radio resources allocated over a slot duration, a particular number of UEs 110 supported in each timing slot, a particular number of UEs 110 that can be attached to the C-RAN 100 at once; etc.

A few scenarios will illustrate specific examples of how a channel configuration 152 might be determined or modified by the self-configuration decision(s) 168. First, instead of running 100 MHz RF bandwidth, the self-configuration instructions 162 might determine that the hardware configuration 150 can only support 60 or 80 MHz RF bandwidth. Second, instead of running FDD, the self-configuration instructions 162 might determine that the hardware configuration 150 can only support TDD on this hardware. Third, instead of running 4×4 MIMO, the self-configuration instructions 162 might determine that the hardware configuration 150 can only support 2×2 MIMO. Fourth, instead of supporting 128 RUs 108, the self-configuration instructions 162 might determine that the hardware configuration 150 can only support 32 RUs 108 using this hardware. Fifth, the software can indicate the hardware configuration 150 can only support the RU 108 and a portion of the DU 105 (instead of running the CU+DU+RU together). So based on the hardware it has to work with, the software will select the configuration to run on that hardware.

The flexi-split decision 165 can indicate which O-RAN split(s) to use, e.g., O-RAN split 2, 6, 7.2x, and/or 8, e.g., so the self-configuration instructions 162 can use it to determine the RAN software configuration, thread configuration, application configuration, channel configuration, etc. The flexi-split decision 165 may be an output (and/or an input) of the self-configuration instructions 162, e.g., determined based on at least the available hardware configuration 150.

An application within the split decision 167 can also be determined, which indicates which applications should be implemented (and optionally on which specific nodes and/or servers), e.g., given the available hardware configuration 150 and/or flexi-split decision 165.

The self-configuration instructions 162 can include self-software configuration instructions 171, software thread configuration instructions 173, and application configuration instructions 175 that can make self-configuration decisions 168, e.g., a flexi-split decision 165 and/or application within the split decision(s) 167.

The C-RAN 100 self-configuration described herein can include a static formula-based determination of the number of total processing cores 142A-I, 144A-F needed (and how many for each specific process) based on the hardware capabilities and the channel configuration. For example, if CPU is 2.4 GHz or 4.8 GHz CPU frequency is used, the processing cores 142A-I, 144A-F needed for PDSCH will be 2 or 1, respectively. For example, example Table 1 might be populated based on the hardware configuration 150 and/or the channel configuration 152 and Table 2 might indicate the number of processing cores 142A-I, 144A-F needed for each processing type as part of the self-configuration decision(s) 168.

TABLE 1

| Attribute | Value | Description | Value(s) |
|---|---|---|---|
| CPU | 4.8 | AVX512 CPU frequency in GHz | 1.2, 1.8, 2.0, |
| Frequency | | | 2.4, 2.7, 4.8 |
| Num | 4 | Number of antenna's supported 2,4,8 | 2, 4, 8 |
| Antennas | 20 | Bandwidth 20, 40, 60, 80,100 MHz | 20, 40, 60, |
| BW | | | 80, 100 |
| SCS | 15 | Sub Carrier Spacing in KHz | 15, 30, 60. |
| | | | 120. 240 |
| TTI | 1000 | Slot duration | |
| DL Reuse | 2 | DL Reuse factor | 1, 2, 4 |
| UL Reuse | 2 | UL Reuse factor | 1, 2, 4 |
| TDD/FDD | 0 | Duplexing supported, FDD-0, TDD-1 | 0, 1 |
| Num Cells | 4 | Number of cells/DU: 1, 2, 4, 8 | 1, 2, 4, 8 |
| O-RAN | 1 | 1-O-RAN, 0-Other Complaint | 0, 1 |
| Complaint | | | |
| Server Type | 0 | Server type, 0-Xeon, 1-ARM, 2-AMD | 0, 1, 2, |

TABLE 2

| Process | Cores |
|---|---|
| DL/UL control and SRS processing | 1 |
| PDSCH processing | 1 |
| PUSCH processing | 2 |
| Fronthaul | 1 |
| PRACH | 1 |
| Total | 6 |

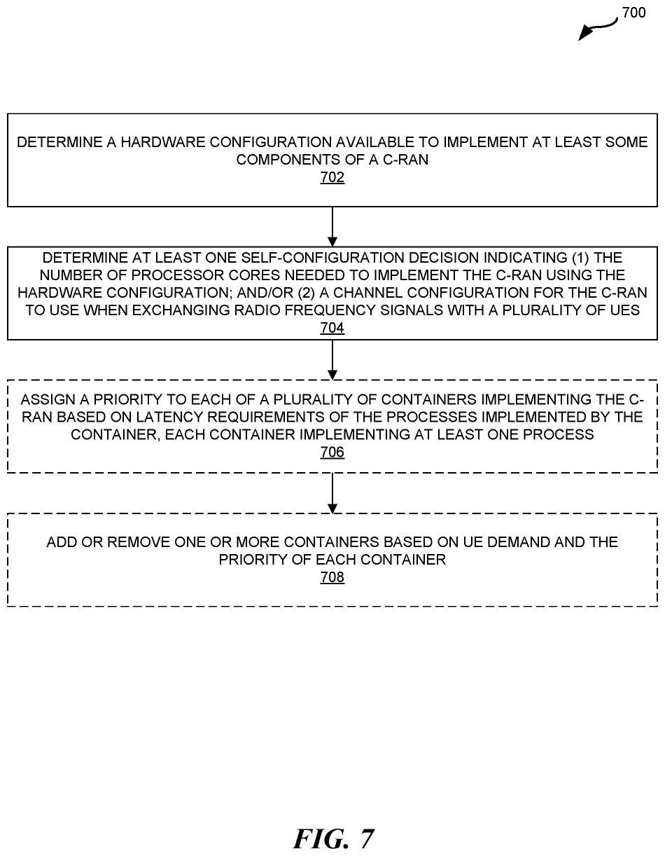

FIG. 7 is a flow diagram illustrating a method 700 for self-configuring a 5G C-RAN 100. The method 700 may be performed by a respective at least one processor in at least one node 140A-C in a scalable cloud environment, e.g., executing instructions stored in at least one electronic memory. Each node 140A-C may implement one or more functional containers/pods, each of which implements some C-RAN 100 functionality, e.g., at least a portion of low PHY processing 130, high PHY processing 128, L2 processing 126, and/or L3 processing 124.

Each node 140A-C may be a logical computing entity implemented using at least one cloud server. In some implementations, a single node 140A-C is implemented on a single server. Additionally or alternatively, more than one node 140A-C may be implemented on a single server. Additionally or alternatively, a single node 140A-C can be implemented across more than one server.

The blocks of the flow diagram shown in FIG. 7 have been arranged in a generally sequential manner for ease of explanation; however, it is to be understood that this arrangement is merely exemplary, and it should be recognized that the processing associated with method 700 (and the blocks shown in FIG. 7) can occur in a different order (for example, where at least some of the processing associated with the blocks is performed in parallel and/or in an event-driven manner). Also, most standard exception handling is not described for ease of explanation; however, it is to be understood that method 700 can and typically would include such exception handling.

The method 700 begins at step 702 where a hardware configuration 150 available to implement at least some components of a C-RAN 100 is determined. For example, the RAN software (implementing L3 124, L2 126, high PHY 128, and/or low PHY 130 processing) can analyze the hardware made available by a cloud vendor and/or a customer desiring to implement a C-RAN 100 on their own hardware.

Without limitation, the hardware configuration 150 can indicate any of the following: number of processing cores 142A-I, 144A-F available, clock frequency of the processing cores 142A-I, 144A-F, CPU make, an amount of memory, Ethernet bandwidth, operating system, virtualization support, PCIe configuration, hardware acceleration, etc. Other possible parameters that may be indicated in the hardware configuration 150: whether the CPU(s) on the node 140A-C have a single processing core 142A-I, 144A-F or multiple processing cores 142A-I, 144A-F, if the processing core(s) 142A-I, 144A-F use a single thread or hyperthreading, input/output acceleration (e.g., DPDK, SRIOV), PCIe pass-through, whether the CPU is a single or dual socket configuration, the CPU pinning/isolation, details of node 140A-C feature discovery, Non-uniform memory access (NUMA) awareness, huge pages configuration, and/or virtual local area network (VLAN) tagging.

The method 700 continues at step 704 where at least one self-configuration decision 168 is made indicating (1) the number of processor cores 142A-I, 144A-F needed to implement the C-RAN 100 using the hardware configuration; and/or (2) the channel configuration 152 for the C-RAN 100 to use when exchanging RF signals with a plurality of UEs 110. More generally, self-configuration decision(s) 168 can indicate how the channel and/or cell-level parameters are supported by the available hardware configuration 150 and/or how the C-RAN 100 will be implemented on the available hardware configuration 150.

More specifically, self-configuration decision(s) 168 may optionally relate to the type and/or number of containers 146A-E, processes 148A-I, and/or applications that will be used to implement the C-RAN 100. Additionally or alternatively, the self-configuration decision(s) 168 can indicate whether the available hardware configuration 150 supports the following in light of the hardware configuration 150 and/or channel configuration 152: a particular RF bandwidth, a particular duplexing scheme, a particular number of MIMO layers, a particular number of RUs 108, a particular number of radio resources allocated over a slot duration, a particular number of UEs 110 supported in each timing slot, a particular number of UEs 110 that can be attached to the C-RAN 100 at once; etc.

Without limitation, the self-configuration decision(s) 168 can determine or modify the following channel configuration 152 parameters in light of the hardware configuration 150: a particular RF bandwidth, a particular duplexing scheme (TDD or FDD), a particular number of MIMO layers (e.g., 2×2, 4×4, etc.), number of RUs 108 to support at one time, a number of radio resources allocated over a slot duration, a number of UEs 110 per timing slot, a number of UEs 110 that can be attached to the C-RAN 100 at once (UE 110 capacity), etc. Other possible parameters that may be indicated in the channel configuration 152: coding rate, modulation mode, number of carriers, subcarrier spacing (SCS) type (also called numerology, UEs 110 per cell, uplink and/or downlink reuse factor, and/or bearers per cell.

A few scenarios will illustrate specific examples of how a channel configuration 152 might be determined or modified by the self-configuration decision(s) 168. First, instead of running 100 MHz RF bandwidth, the self-configuration instructions 162 might determine that the hardware configuration 150 can only support 60 or 80 MHz RF bandwidth. Second, instead of running FDD, the self-configuration instructions 162 might determine that the hardware configuration 150 can only support TDD on this hardware. Third, instead of running 4×4 MIMO, the self-configuration instructions 162 might determine that the hardware configuration 150 can only support 2×2 MIMO. Fourth, instead of supporting 128 RUs 108, the self-configuration instructions 162 might determine that the hardware configuration 150 can only support 32 RUs 108 using this hardware. Fifth, the software can indicate the hardware configuration 150 can only support the RU 108 and a portion of the DU 105 (instead of running the CU+DU+RU together). So based on the hardware it has to work with, the software will select the configuration to run on that hardware.

Step 704 can include a static formula to determine of the number of total processing cores 142A-I, 144A-F needed and optionally how many for each specific RAN process (like Table 2 above) based on the hardware capabilities and the channel configuration. For example, if CPU is 2.4 GHz or 4.8 GHz CPU frequency is used, the processing cores 142A-I, 144A-F needed for PDSCH will be 2 or 1, respectively. For example, step 704 may determine how many processing cores 142A-I, 144A-F are needed to process any (or all) of the following channels: Physical Downlink Shared Channel (PDSCH), a Physical Uplink Shared Channel (PUSCH), scheduling, and a Physical Random Access Channel (PRACH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), and a Phase Tracking Reference Signal.

Step 704 can optionally include assigning containers 146A-E to specific nodes 140A-C and/or processing cores 142A-I, 144A-F based on the hardware configuration 150, e.g., if the container 146A-E requires 10 processing cores 142A-I, 144A-F for 4×4 MIMO and the deployed hardware configuration 150 has only 5 processing cores 142A-I, 144A-F available, a user alarm may be triggered and 2×2 MIMO can be configured to operate with 5 processing cores 142A-I, 144A-F. Similar actions could be taken for the clock frequency, Ethernet bandwidth, and memory interface, etc.

Step 704 can optionally include determining where different processing is performed, e.g., cloud hardware, central cloud hardware, edge cloud hardware, far-edge cloud, non-cloud hardware, etc. This determination can be made based on the available hardware configuration 150, the physical location of specific hardware, the latency requirements of different processing, and/or the 5G channel configuration 152 for the C-RAN 100. This can include offloading processing non-real-time latency (and non-time-critical) processing far-edge customer hardware and keeping real-time and time-critical processing on central cloud or edge nodes.

The self-configuration decision in step 704 can optionally determine the processing load and PODs that can run on the customer hardware based on the service-aware RAN processing, e.g., Enhanced Mobile Broadband (eMBB) Service, Massive Machine-Type Communications (mMTC) Service, and/or Ultra-Reliable Low-Latency Communication (URLLC).

The self-configuration decision in step 704 can optionally indicate which O-RAN split(s) to use, e.g., O-RAN split 2, 6, 7.2x, and/or 8.

The method 700 continues at optional step 706 where each of a plurality of containers 146A-E implementing the C-RAN 100 are assigned a priority based on latency constraints for the process 148A-I, each of the containers 146A-E implementing at least one respective process. Without limitation, processes 148A-I can include PDSCH processing 148A, 148I, DL+UL control processing 148B, PUSCH processing 148C, 148E-G, hardware acceleration processing 148D, SRS processing 148H. In some configurations, different processes can be implemented in the same container 146A-E.

A single core 142A-I, 144A-F could implement one or more containers 146A-E, each container 146A-E implementing one or more processes. In some configurations, a single container 146A-E could be implemented using more than one core 142A-I, 144A-F or multiple containers 146A-E could be implemented using a single core 142A-I, 144A-F.

Optional step 706 may include classifying each process as mandatory or optional after which each container 146A-E implementing at least one mandatory process would be considered mandatory. Mandatory processes are those required for the operation of the C-RAN 100 and may be referred to as “core” processing or functionality. For example, basic downlink and uplink channel processing, UE 110 attachment, etc. Mandatory processes cannot be dynamically removed.

Optional processes are used for scaling (e.g., in response to an increase in network demand). Optional processes can be dynamically deployed and removed. The base variant (with minimal optional containers) can run on a desktop computer after which scaling of the C-RAN 100 could optionally be performed with additional hardware.

Additionally or alternatively, optional step 706 may include assigning a numerical priority, e.g., an integer from 1-3, 1-10, 1-100, etc. Where a first process (e.g., implemented in at least one container 146A-E) is subject to more rigid latency constraints (e.g., real-time constraints or time-critical) than a second priority (e.g., implemented in at least one container 146A-E), the first process is assigned a higher priority than the second process. Generally, time-critical processes (e.g., relating to RU 108 communication) are assigned higher priority and will be implemented in nodes 140A-C with higher core frequency.

The method 700 continues at optional step 708 where one or more containers 146A-E are added or removed based on any of the following: UE 110 demand, demand on the RAN 100 workload, available resources at a given time for each container 146A-E, and/or the priority of each container 146A-E. For example, if UE 110 demand changes, optional PUSCH processes 148E-G may be added or removed accordingly. Typically, mandatory containers 146A-E would not be removed dynamically.

In summary, cloud vendors can have nodes 140A-C with a variety of configurations, e.g., x86, AMD, ARM and with multiple generations of hardware. The self-configuration feature described herein enables DMS, CU, DU−L2, and DU−L1 to be implemented on a cloud and is compatible with many different cloud hardware configurations 150. This compatibility reduces the cost of deploying on the cloud.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. For example, where a computing device is described as performing an action, the computing device may carry out this action using at least one processor executing instructions stored on at least one memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Terminology

Brief definitions of terms, abbreviations, and phrases used throughout this application are given below.

The term “determining” and its variants may include calculating, extracting, generating, computing, processing, deriving, modeling, investigating, looking up (e.g., looking up in a table, a database or another data structure), ascertaining and the like. Also, “determining” may also include receiving (e.g., receiving information), accessing (e.g., accessing data in a memory) and the like. Also, “determining” may include resolving, selecting, choosing, establishing and the like.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The terms “connected”, “coupled”, and “communicatively coupled” and related terms may refer to direct or indirect connections. If the specification states a component or feature “may,” “can,” “could,” or “might” be included or have a characteristic, that particular component or feature is not required to be included or have the characteristic.

The terms “responsive” or “in response to” may indicate that an action is performed completely or partially in response to another action. The term “module” refers to a functional component implemented in software, hardware, or firmware (or any combination thereof) component.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

In conclusion, the present disclosure provides novel systems, methods, and arrangements for a hardware-agnostic C-RAN 100. While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### EXAMPLES

Example 1 includes a cloud radio access network (C-RAN) comprising: at least one cloud node implementing: at least a portion of layer-1 (L1) processing for a distributed unit (DU) using a first at least one processing core; layer-2 (L2) processing for the DU using a second at least one processing core; and wherein the L1 processing and the L2 processing are for an air interface used by the C-RAN to exchange radio frequency signals with at least one user equipment (UE); wherein the L1 processing and the L2 processing communicate via a network functional application platform interface (nFAPI).

Example 2 includes the C-RAN of Example 1, wherein the at least one cloud node implements the L1 processing on a first cloud node and the L2 processing on a second cloud node.

Example 3 includes the C-RAN of any of Examples 1-2, wherein the at least one cloud node implements the L1 processing and the L2 processing on a same cloud node.

Example 4 includes the C-RAN of any of Examples 1-3, wherein the L2 processing converts data from a first protocol to a second protocol before transmitting to the L1 processing.

Example 5 includes the C-RAN of Example 4, wherein the L2 processing communicates with the L1 processing via nFAPI with a buffering window to align latency requirements of the L2 processing and the L1 processing.

Example 6 includes the C-RAN of any of Examples 4-5, wherein a respective buffer for the L1 processing and the L2 processing accounts for delays caused by the converting of the data from the first protocol to the second protocol, transport latency between the L1 processing and the L2 processing, and L1 polling between the L1 processing and the L2 processing.

Example 7 includes the C-RAN of any of Examples 1-6, wherein the at least a portion of the L1 processing comprises processing for any of the following: a Physical Downlink Shared Channel (PDSCH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), a Phase Tracking Reference Signal, a Physical Uplink Shared Channel (PUSCH), scheduling, and a Physical Random Access Channel (PRACH).

Example 8 includes the C-RAN of any of Examples 1-7, wherein the at least a portion of the L1 processing comprises processing for any of the following: the nFAPI interface, a Sounding Reference Signal (SRS), a Synchronization Signal Block (SSB), and a fronthaul interface between the at least one cloud node and at least one remote unit using nFAPI.

Example 9 includes the C-RAN of any of Examples 1-8, wherein the at least a portion of the L1 processing comprises any of the following: channel coding, resource element mapping, MIMO mapping, scrambling, and modulation.

Example 10 includes the C-RAN of any of Examples 1-9, wherein the L2 processing comprises processing for any of the following: Medium Access Control (MAC), Radio Link Control (RLC), MAC scheduling.

Example 11 includes the C-RAN of any of Examples 1-10, wherein the L2 processing comprises processing for any of the following: Hybrid Automatic Repeat Request (HARD), Physical Random Access Channel (PRACH), and the nFAPI interface.

Example 12 includes the C-RAN of any of Examples 1-11, further comprising at least one remote unit that exchanges the radio frequency signals with the at least one UE, wherein the at least one remote unit performs additional layer-1 processing comprising any of the following: digital-to-analog conversion, RF upconversion, RF downconversion, amplification, radiation, pre-coding, beamforming, and analog RF control processing.

Example 13 includes the C-RAN of any of Examples 1-12, wherein the at least one cloud node further implements a central unit (CU) on a same or different cloud node implementing the L2 processing, the CU comprising a controller unit user-plane (CU-UP) portion and a controller unit control-plane (CU-CP) portion.

Example 14 includes the C-RAN of Example 13, wherein the CU-CP portion performs S1 interface processing, X2 interface processing, and Radio Resource Control (RRC) processing, wherein the CU-CP portion communicates with the second cloud node using the any of an F1-C interface, 5G NGc and 5G NGu interfaces, an S1-U interface, and an S1MME interface.

Example 15 includes the C-RAN of any of Examples 13-14, wherein the CU-UP portion performs Service Data Adaptation Protocol (SDAP) processing and Packet Data Convergence Protocol (PDCP) processing, wherein the CU-UP portion communicates with the second cloud node using an F1-U interface.

Example 16 includes a method for layer-1 (L1) and layer-2 (L2) processing in a cloud radio access network (C-RAN) comprising: performing at least a portion of L1 processing for a distributed unit (DU) in at least one cloud node using a first at least one processing core; performing L2 processing for the DU in the at least one cloud node using a second at least one processing core; and wherein the L1 and L2 processing are for an air interface used by the C-RAN to exchange radio frequency signals with at least one user equipment (UE); wherein the L1 processing and the L2 processing communicate via a network functional application platform interface (nFAPI).

Example 17 includes the method of Example 16, wherein performing at least a portion of the L1 processing for the DU comprises performing at least a portion of the L1 processing for the DU in a first cloud node; wherein performing the L2 processing for the DU comprises performing the L2 processing for the DU in a second cloud node.

Example 18 includes the method of any of Examples 16-17, wherein the L1 processing is performed on a same cloud node as the L2 processing.

Example 19 includes the method of any of Examples 16-18, wherein the L2 processing comprises converting data from a first protocol to a second protocol before transmitting to the L1 processing.

Example 20 includes the method of Example 19, wherein the L2 processing communicates with the L1 processing via nFAPI with a buffering window to align latency requirements of the L2 processing and the L1 processing.

Example 21 includes the method of any of Examples 19-20, wherein a respective buffer for the L1 processing and the L2 processing accounts for delays caused by the converting of the data from the first protocol to the second protocol, transport latency between the L1 processing and the L2 processing, and L1 polling between the L1 processing and the L2 processing.

Example 22 includes the method of any of Examples 16-21, wherein the performing at least a portion of L1 processing comprises processing for any of the following: a Physical Downlink Shared Channel (PDSCH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), a Phase Tracking Reference Signal, a Physical Uplink Shared Channel (PUSCH), scheduling, and a Physical Random Access Channel (PRACH).

Example 23 includes the method of any of Examples 16-22, wherein the performing at least a portion of L1 processing comprises processing for any of the following: the nFAPI interface, a Sounding Reference Signal (SRS), a Synchronization Signal Block (SSB), and a fronthaul interface between the at least one cloud node and at least one remote unit using nFAPI.

Example 24 includes the method of any of Examples 16-23, wherein the performing at least a portion of L1 processing comprises any of the following: channel coding, resource element mapping, MIMO mapping, scrambling, and modulation.

Example 25 includes the method of any of Examples 16-24, wherein the performing L2 processing comprises processing for any of the following: Medium Access Control (MAC), Radio Link Control (RLC), MAC scheduling.

Example 26 includes the method of any of Examples 16-25, wherein the performing L2 processing comprises processing for any of the following: Hybrid Automatic Repeat Request (HARD), Physical Random Access Channel (PRACH), and the nFAPI interface.

Example 27 includes the method of any of Examples 16-26, further comprising: exchanging, using at least one remote unit, the radio frequency signals with the at least one UE; and performing, at the at least one remote unit, additional layer-1 processing comprising any of the following: digital-to-analog conversion, RF upconversion, RF downconversion, amplification, radiation, pre-coding, beamforming, and analog RF control processing.

Example 28 includes the method of any of Examples 16-27, further comprising performing layer-3 (L3) processing for a central unit (CU) on a same or different cloud node implementing the L2 processing, the CU comprising a controller unit user-plane (CU-UP) portion and a controller unit control-plane (CU-CP) portion.

Example 29 includes the method of Example 28, wherein performing, at the CU-CP portion, S1 interface processing, X1 interface processing, and Radio Resource Control (RRC) processing, wherein the CU-CP portion communicates with the second cloud node using the any of an F1-C interface, 5G NGc and 5G NGu interfaces, an S1-U interface, and an S1MME interface.

Example 30 includes the method of any of Examples 28-29, wherein performing, at the CU-UP portion, Service Data Adaptation Protocol (SDAP) processing and Packet Data Convergence Protocol (PDCP) processing, wherein the CU-UP portion communicates with the second cloud node using an F1-U interface.

Example 31 includes a cloud radio access network (C-RAN) implemented at least partially using at least one node, the at least one node configured to: determine a hardware configuration available to implement at least some components and configuration of the C-RAN; and determine, based on at least the hardware configuration, at least one self-configuration decision indicating any of the following: a number of processor cores needed to implement the C-RAN using the hardware configuration; and a channel configuration for the C-RAN to use when exchanging radio frequency (RF) signals with a plurality of user equipment (UEs).

Example 32 includes the C-RAN of Example 31, wherein the at least one node is further configured to determine additional self-configuration decisions that indicate whether the available hardware configuration supports the following in light of the hardware configuration: a particular RF bandwidth, a particular duplexing scheme, a particular number of MIMO layers, a particular number of RUs, a particular number of UEs transmitting in each timing slot, a particular number of UEs that can be attached to the C-RAN at once.

Example 33 includes the C-RAN of any of Examples 31-32, wherein the hardware configuration indicates any of the following: a number of processing cores available in the at least one node, a clock frequency of the processing cores, a make of a central processing unit (CPU) in the at least one node, an amount of memory available in the at least one node, Ethernet bandwidth supported in the at least one node, operating system implemented in the at least one node, virtualization support in the at least one node, Peripheral Component Interconnect Express (PCIe) configuration of the at least one node, and hardware acceleration supported in the at least one node.

Example 34 includes the C-RAN of any of Examples 31-33, wherein the channel configuration indicates any of the following: an RF bandwidth, a number of radio resources allocated over a slot duration, a duplexing scheme, a number of MIMO layers, a number of RUs to support, a number of UEs per slot, and a number of UEs that can be attached to the C-RAN at once.

Example 35 includes the C-RAN of any of Examples 31-34, wherein the self-configuration decision further indicates a number of processor cores needed to implement any of the following processing: Physical Downlink Shared Channel (PDSCH), a Physical Uplink Shared Channel (PUSCH), scheduling, and a Physical Random Access Channel (PRACH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), and a Phase Tracking Reference Signal.

Example 36 includes the C-RAN of any of Examples 31-35, wherein the self-configuration decision further indicates which containers will run on which processing cores and nodes.

Example 37 includes the C-RAN of any of Examples 31-36, wherein the at least one node is further configured to assign a priority to each of a plurality of containers implementing the C-RAN based on latency constraints of processes implemented by the respective container, each container implementing at least one process.

Example 38 includes the C-RAN of Example 37, wherein different processes implemented by a same container are assigned different priorities based on the latency constraints of the different processes.

Example 39 includes the C-RAN of any of Examples 37-38, wherein the at least one node is further configured to add or remove one or more of the containers based on any of the following: UE demand, demand on RAN workload, available resources at a given time for each container, and the priority of the container.

Example 40 includes the C-RAN of any of Examples 37-39, wherein the at least one node is further configured to assign a higher priority to each container implementing at least one process subject to real-time constraints than for each container implementing at least one process not subject to real-time constraints.

Example 41 includes the C-RAN of Example 40, wherein the at least one node is further configured to add at least one PUSCH process in response to UE demand increasing.

Example 42 includes a method for self-configuring a cloud radio access network (C-RAN) implemented at least partially using at least one node, the method being performed by the at least one node, comprising: determining a hardware configuration available to implement at least some components and configuration of the C-RAN; and determining, based on at least the hardware configuration, at least one self-configuration decision indicating any of the following: a number of processor cores needed to implement the C-RAN using the hardware configuration; and a channel configuration for the C-RAN to use when exchanging radio frequency (RF) signals with a plurality of user equipment (UEs).

Example 43 includes the method of Example 42, further comprising determining additional self-configuration decisions that indicate whether the available hardware configuration supports the following in light of the hardware configuration: a particular RF bandwidth, a particular duplexing scheme, a particular number of MIMO layers, a particular number of RUs, a particular number of UEs transmitting in each timing slot, a particular number of UEs that can be attached to the C-RAN at once.

Example 44 includes the method of any of Examples 42-43, wherein the hardware configuration indicates any of the following: a number of processing cores available in the at least one node, a clock frequency of the processing cores, a make of a central processing unit (CPU) in the at least one node, an amount of memory available in the at least one node, Ethernet bandwidth supported in the at least one node, operating system implemented in the at least one node, virtualization support in the at least one node, Peripheral Component Interconnect Express (PCIe) configuration of the at least one node, and hardware acceleration supported in the at least one node.

Example 45 includes the method of any of Examples 42-44, wherein the channel configuration indicates any of the following: an RF bandwidth, a number of radio resources allocated over a slot duration, a duplexing scheme, a number of MIMO layers, a number of RUs to support, a number of UEs per slot, and a number of UEs that can be attached to the C-RAN at once.

Example 46 includes the method of any of Examples 42-45, wherein the self-configuration decision further indicates a number of processor cores needed to implement any of the following processing: Physical Downlink Shared Channel (PDSCH), a Physical Uplink Shared Channel (PUSCH), scheduling, and a Physical Random Access Channel (PRACH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), and a Phase Tracking Reference Signal.

Example 47 includes the method of any of Examples 42-46, wherein the self-configuration decision further indicates which containers will run on which processing cores and nodes.

Example 48 includes the method of any of Examples 42-47, further comprising assigning a priority to each of a plurality of containers implementing the C-RAN based on latency constraints of processes implemented by the respective container, each container implementing at least one process.

Example 49 includes the method of Example 48, wherein different processes implemented by a same container are assigned different priorities based on the latency constraints of the different processes.

Example 50 includes the method of Example 49, further comprising adding or removing one or more of the containers based on any of the following: UE demand, demand on RAN workload, available resources at a given time for each container, and the priority of the container.

Example 51 includes the method of any of Examples 49-50, further comprising assigning a higher priority to each container implementing at least one process subject to real-time constraints than for each container implementing at least one process not subject to real-time constraints.

Example 52 includes the method of Example 51, further comprising adding at least one PUSCH process in response to UE demand increasing.

1. A cloud radio access network (C-RAN) comprising:
at least one cloud node implementing:
at least a portion of layer-1 (L1) processing for a distributed unit (DU) using a first at least one processing core;
layer-2 (L2) processing for the DU using a second at least one processing core; and
wherein the L1 processing and the L2 processing are for an air interface used by the C-RAN to exchange radio frequency signals with at least one user equipment (UE);
wherein the L1 processing and the L2 processing communicate via a network functional application platform interface (nFAPI).

2. The C-RAN of claim 1, wherein the at least one cloud node implements the L1 processing on a first cloud node and the L2 processing on a second cloud node.

3. The C-RAN of claim 1, wherein the at least one cloud node implements the L1 processing and the L2 processing on a same cloud node.

4. The C-RAN of claim 1, wherein the L2 processing converts data from a first protocol to a second protocol before transmitting to the L1 processing.

5. The C-RAN of claim 4, wherein the L2 processing communicates with the L1 processing via nFAPI with a buffering window to align latency requirements of the L2 processing and the L1 processing.

6. The C-RAN of claim 4, wherein a respective buffer for the L1 processing and the L2 processing accounts for delays caused by the converting of the data from the first protocol to the second protocol, transport latency between the L1 processing and the L2 processing, and L1 polling between the L1 processing and the L2 processing.

7. The C-RAN of claim 1, wherein the at least a portion of the L1 processing comprises processing for any of the following: a Physical Downlink Shared Channel (PDSCH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), a Phase Tracking Reference Signal, a Physical Uplink Shared Channel (PUSCH), scheduling, and a Physical Random Access Channel (PRACH).

8. The C-RAN of claim 1, wherein the at least a portion of the L1 processing comprises processing for any of the following: the nFAPI interface, a Sounding Reference Signal (SRS), a Synchronization Signal Block (SSB), and a fronthaul interface between the at least one cloud node and at least one remote unit using nFAPI.

9. The C-RAN of claim 1, wherein the at least a portion of the L1 processing comprises any of the following: channel coding, resource element mapping, MIMO mapping, scrambling, and modulation.

10. The C-RAN of claim 1, wherein the L2 processing comprises processing for any of the following: Medium Access Control (MAC), Radio Link Control (RLC), MAC scheduling.

11. The C-RAN of claim 1, wherein the L2 processing comprises processing for any of the following: Hybrid Automatic Repeat Request (HARD), Physical Random Access Channel (PRACH), and the nFAPI interface.

12. The C-RAN of claim 1, further comprising at least one remote unit that exchanges the radio frequency signals with the at least one UE, wherein the at least one remote unit performs additional layer-1 processing comprising any of the following: digital-to-analog conversion, RF upconversion, RF downconversion, amplification, radiation, pre-coding, beamforming, and analog RF control processing.

13. The C-RAN of claim 1, wherein the at least one cloud node further implements a central unit (CU) on a same or different cloud node implementing the L2 processing, the CU comprising a controller unit user-plane (CU-UP) portion and a controller unit control-plane (CU-CP) portion.

14. The C-RAN of claim 13, wherein the CU-CP portion performs S1 interface processing, X2 interface processing, and Radio Resource Control (RRC) processing, wherein the CU-CP portion communicates with the second cloud node using the any of an F1-C interface, 5G NGc and 5G NGu interfaces, an S1-U interface, and an S1MME interface.

15. The C-RAN of claim 13, wherein the CU-UP portion performs Service Data Adaptation Protocol (SDAP) processing and Packet Data Convergence Protocol (PDCP) processing, wherein the CU-UP portion communicates with the second cloud node using an F1-U interface.

16. A method for layer-1 (L1) and layer-2 (L2) processing in a cloud radio access network (C-RAN) comprising:
performing at least a portion of L1 processing for a distributed unit (DU) in at least one cloud node using a first at least one processing core;
performing L2 processing for the DU in the at least one cloud node using a second at least one processing core; and
wherein the L1 and L2 processing are for an air interface used by the C-RAN to exchange radio frequency signals with at least one user equipment (UE);
wherein the L1 processing and the L2 processing communicate via a network functional application platform interface (nFAPI).

17. The method of claim 16,
wherein performing at least a portion of the L1 processing for the DU comprises performing at least a portion of the L1 processing for the DU in a first cloud node;
wherein performing the L2 processing for the DU comprises performing the L2 processing for the DU in a second cloud node.

18. The method of claim 16, wherein the L1 processing is performed on a same cloud node as the L2 processing.

19. The method of claim 16, wherein the L2 processing comprises converting data from a first protocol to a second protocol before transmitting to the L1 processing.

20. The method of claim 19, wherein the L2 processing communicates with the L1 processing via nFAPI with a buffering window to align latency requirements of the L2 processing and the L1 processing.

21. The method of claim 19, wherein a respective buffer for the L1 processing and the L2 processing accounts for delays caused by the converting of the data from the first protocol to the second protocol, transport latency between the L1 processing and the L2 processing, and L1 polling between the L1 processing and the L2 processing.

22. The method of claim 16, wherein the performing at least a portion of L1 processing comprises processing for any of the following: a Physical Downlink Shared Channel (PDSCH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), a Phase Tracking Reference Signal, a Physical Uplink Shared Channel (PUSCH), scheduling, and a Physical Random Access Channel (PRACH).

23. The method of claim 16, wherein the performing at least a portion of L1 processing comprises processing for any of the following: the nFAPI interface, a Sounding Reference Signal (SRS), a Synchronization Signal Block (SSB), and a fronthaul interface between the at least one cloud node and at least one remote unit using nFAPI.

24. The method of claim 16, wherein the performing at least a portion of L1 processing comprises any of the following: channel coding, resource element mapping, MIMO mapping, scrambling, and modulation.

25. The method of claim 16, wherein the performing L2 processing comprises processing for any of the following: Medium Access Control (MAC), Radio Link Control (RLC), MAC scheduling.

26. The method of claim 16, wherein the performing L2 processing comprises processing for any of the following: Hybrid Automatic Repeat Request (HARD), Physical Random Access Channel (PRACH), and the nFAPI interface.

27. The method of claim 16, further comprising:
exchanging, using at least one remote unit, the radio frequency signals with the at least one UE; and
performing, at the at least one remote unit, additional layer-1 processing comprising any of the following: digital-to-analog conversion, RF upconversion, RF downconversion, amplification, radiation, pre-coding, beamforming, and analog RF control processing.

28. The method of claim 16, further comprising performing layer-3 (L3) processing for a central unit (CU) on a same or different cloud node implementing the L2 processing, the CU comprising a controller unit user-plane (CU-UP) portion and a controller unit control-plane (CU-CP) portion.

29. The method of claim 28, wherein performing, at the CU-CP portion, S1 interface processing, X1 interface processing, and Radio Resource Control (RRC) processing, wherein the CU-CP portion communicates with the second cloud node using the any of an F1-C interface, 5G NGc and 5G NGu interfaces, an S1-U interface, and an S1MME interface.

30. The method of claim 28, wherein performing, at the CU-UP portion, Service Data Adaptation Protocol (SDAP) processing and Packet Data Convergence Protocol (PDCP) processing, wherein the CU-UP portion communicates with the second cloud node using an F1-U interface.

31. A cloud radio access network (C-RAN) implemented at least partially using at least one node, the at least one node configured to:
determine a hardware configuration available to implement at least some components and configuration of the C-RAN; and
determine, based on at least the hardware configuration, at least one self-configuration decision indicating any of the following:
a number of processor cores needed to implement the C-RAN using the hardware configuration; and
a channel configuration for the C-RAN to use when exchanging radio frequency (RF) signals with a plurality of user equipment (UEs).

32. The C-RAN of claim 31, wherein the at least one node is further configured to determine additional self-configuration decisions that indicate whether the available hardware configuration supports the following in light of the hardware configuration: a particular RF bandwidth, a particular duplexing scheme, a particular number of MIMO layers, a particular number of RUs, a particular number of UEs transmitting in each timing slot, a particular number of UEs that can be attached to the C-RAN at once.

33. The C-RAN of claim 31, wherein the hardware configuration indicates any of the following: a number of processing cores available in the at least one node, a clock frequency of the processing cores, a make of a central processing unit (CPU) in the at least one node, an amount of memory available in the at least one node, Ethernet bandwidth supported in the at least one node, operating system implemented in the at least one node, virtualization support in the at least one node, Peripheral Component Interconnect Express (PCIe) configuration of the at least one node, and hardware acceleration supported in the at least one node.

34. The C-RAN of claim 31, wherein the channel configuration indicates any of the following: an RF bandwidth, a number of radio resources allocated over a slot duration, a duplexing scheme, a number of MIMO layers, a number of RUs to support, a number of UEs per slot, and a number of UEs that can be attached to the C-RAN at once.

35. The C-RAN of claim 31, wherein the self-configuration decision further indicates a number of processor cores needed to implement any of the following processing: Physical Downlink Shared Channel (PDSCH), a Physical Uplink Shared Channel (PUSCH), scheduling, and a Physical Random Access Channel (PRACH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), and a Phase Tracking Reference Signal.

36. The C-RAN of claim 31, wherein the self-configuration decision further indicates which containers will run on which processing cores and nodes.

37. The C-RAN of claim 31, wherein the at least one node is further configured to assign a priority to each of a plurality of containers implementing the C-RAN based on latency constraints of processes implemented by the respective container, each container implementing at least one process.

38. The C-RAN of claim 37, wherein different processes implemented by a same container are assigned different priorities based on the latency constraints of the different processes.

39. The C-RAN of claim 37, wherein the at least one node is further configured to add or remove one or more of the containers based on any of the following: UE demand, demand on RAN workload, available resources at a given time for each container, and the priority of the container.

40. The C-RAN of claim 37, wherein the at least one node is further configured to assign a higher priority to each container implementing at least one process subject to real-time constraints than for each container implementing at least one process not subject to real-time constraints.

41. The C-RAN of claim 40, wherein the at least one node is further configured to add at least one PUSCH process in response to UE demand increasing.

42. A method for self-configuring a cloud radio access network (C-RAN) implemented at least partially using at least one node, the method being performed by the at least one node, comprising:
determining a hardware configuration available to implement at least some components and configuration of the C-RAN; and
determining, based on at least the hardware configuration, at least one self-configuration decision indicating any of the following:
a number of processor cores needed to implement the C-RAN using the hardware configuration; and
a channel configuration for the C-RAN to use when exchanging radio frequency (RF) signals with a plurality of user equipment (UEs).

43. The method of claim 42, further comprising determining additional self-configuration decisions that indicate whether the available hardware configuration supports the following in light of the hardware configuration: a particular RF bandwidth, a particular duplexing scheme, a particular number of MIMO layers, a particular number of RUs, a particular number of UEs transmitting in each timing slot, a particular number of UEs that can be attached to the C-RAN at once.

44. The method of claim 42, wherein the hardware configuration indicates any of the following: a number of processing cores available in the at least one node, a clock frequency of the processing cores, a make of a central processing unit (CPU) in the at least one node, an amount of memory available in the at least one node, Ethernet bandwidth supported in the at least one node, operating system implemented in the at least one node, virtualization support in the at least one node, Peripheral Component Interconnect Express (PCIe) configuration of the at least one node, and hardware acceleration supported in the at least one node.

45. The method of claim 42, wherein the channel configuration indicates any of the following: an RF bandwidth, a number of radio resources allocated over a slot duration, a duplexing scheme, a number of MIMO layers, a number of RUs to support, a number of UEs per slot, and a number of UEs that can be attached to the C-RAN at once.

46. The method of claim 42, wherein the self-configuration decision further indicates a number of processor cores needed to implement any of the following processing: Physical Downlink Shared Channel (PDSCH), a Physical Uplink Shared Channel (PUSCH), scheduling, and a Physical Random Access Channel (PRACH), a Physical Downlink Control Channel (PDCCH), a Physical Uplink Control Channel (PUCCH), a Sounding Reference Signal (SRS), a Physical Broadcast Control Channel (PBCH), a Primary Synchronization Signal (PSS), a Secondary Synchronization Signal (SSS), a Cell Specific Reference Signal (CS-RS), a Tracking reference Signal, a Demodulation Reference Signal (DMRS), and a Phase Tracking Reference Signal.

47. The method of claim 42, wherein the self-configuration decision further indicates which containers will run on which processing cores and nodes.

48. The method of claim 42, further comprising assigning a priority to each of a plurality of containers implementing the C-RAN based on latency constraints of processes implemented by the respective container, each container implementing at least one process.

49. The method of claim 48, wherein different processes implemented by a same container are assigned different priorities based on the latency constraints of the different processes.

50. The method of claim 49, further comprising adding or removing one or more of the containers based on any of the following: UE demand, demand on RAN workload, available resources at a given time for each container, and the priority of the container.

51. The method of claim 49, further comprising assigning a higher priority to each container implementing at least one process subject to real-time constraints than for each container implementing at least one process not subject to real-time constraints.

52. The method of claim 51, further comprising adding at least one PUSCH process in response to UE demand increasing.
